(19) United States
(12) Patent Application Publication
(10) Pub. No.: US 2025/0211051 A1
(43) Pub. Date: Jun. 26, 2025

(54) CONNECTION PLATE FOR THE ELECTRICAL AND HYDRAULIC CONNECTION OF THE HOLLOW CONDUCTORS OF AN INTERNALLY COOLED ELECTRICAL MACHINE AND ELECTRICAL MACHINE WITH SUCH A CONNECTION PLATE

(71) Applicant: DYNAMIC E FLOW GMBH, Valley (DE)

(72) Inventor: Markus Erlacher, Tuntenhausen (DE)

(21) Appl. No.: 18/852,176

(22) PCT Filed: Mar. 13, 2023
(86) PCT No.: PCT/EP2023/056290

§ 371 Date: Sep. 27, 2024

(30) Foreign Application Priority Data
Mar. 28, 2022 (DE) 10 2022 107 231.2

(51) Int. Cl. H02K 3/50; H02K 3/22; H02K 3/24

(52) U.S. Cl. CPC H02K 3/50; H02K 3/22; H02K 3/24

(57) ABSTRACT

The invention relates to an electrical machine (1) with a winding formed from hollow conductors (5), wherein the hollow conductors (5) each have open ends (12) via which a coolant can be fed into the hollow conductors (5) or can emerge from the hollow conductors (5). The electrical machine (1) comprises a connection unit (3) for the electrical and hydraulic connection of the hollow conductors (5) with a connection plate (6), in which several electrical conductor tracks (11) are integrated, wherein the connection plate (6) has several through-openings (15), in which the ends (12) of the hollow conductors (5) are arranged.

The invention relates to an internally cooled electrical machine with a hollow conductor winding and a connection plate for the electrical and hydraulic connection of the hollow conductors.

### BACKGROUND OF THE INVENTION

Internally cooled electrical machines with a hollow conductor winding are known from the state of the art. The hollow conductors have an internal channel through which a coolant is passed in order to cool the electrical machine during operation.

Hollow conductors known from the state of the art are usually in the form of hairpins or pins. The pins or hairpins are usually rigid winding pieces made of copper, which are inserted into slots in the stator of the electrical machine and generate the required magnetic field when the electrical machine is in operation. Another embodiment of internally cooled electrical machines comprises a winding made of thin hollow wire that is wound into coils.

The hollow conductors have open ends through which a coolant can be fed into or exit from the hollow conductor. The known hollow conductors are usually provided with an electrically insulating coating on their outer surface.

DE 10 2018 218 668 A1 discloses an electrical machine with a winding formed from hollow conductors, wherein the hollow conductors each have open ends via which a coolant can be fed into the hollow conductors or can exit from the hollow conductors, and with a connection unit for the electrical and hydraulic connection of the hollow conductors, comprising a connection plate in which a plurality of electrical conductor tracks are integrated, wherein the connection plate has a plurality of through holes in which the ends of the hollow conductors are arranged. Another electrical machine with a hollow conductor winding is known from DE 10 2018 129 230 A1.

For internally cooled electrical machines having a hollow conductor winding, the electrical and hydraulic connection of the individual conductors poses a technical challenge.

### TASK OF THE INVENTION

It is an object of the present invention to create an electrical machine having a winding formed from hollow conductors, which comprises a connection unit which makes it possible to connect the ends of the individual hollow conductors easily and quickly electrically and hydraulically.

This object is solved in accordance with the invention by the features specified in claim 1. Further embodiments of the invention are shown in the sub-claims.

According to the invention, an internally cooled electrical machine with a winding formed from hollow conductors is proposed, in which the hollow conductors each have open ends via which a coolant can be fed into or exit from the hollow conductors. The electrical machine according to the invention comprises a connection unit for the electrical and hydraulic connection of the hollow conductors, which comprises a connection plate in which a plurality of electrical conductor tracks are integrated, the plate also having a plurality of through holes in which the ends of the hollow conductors are arranged. The hollow conductor ends are in electrical contact with at least one of the conductor tracks integrated in the plate.

In principle, the conductor tracks can run in one plane or on different planes within the plate. The connection plate preferably comprises one or more embedded conductor tracks running under the surface.

In a special embodiment of the invention, the connection plate can be formed as a sandwich construction of several superimposed plates or layers. Each layer may be made of an insulating material and may comprise one or more conductive tracks. The individual layers can, for example, be glued together, overmolded with plastic, bonded with resin, welded or otherwise joined together. The layers or plates are preferably arranged one above the other in an axial direction of the electrical machine.

According to a special embodiment of the invention, the connection plate, which may comprise individual layers, has a recess in its surface in the area of at least one of the through openings, which makes it possible to electrically contact a hollow conductor end located in the relevant through-opening with a conductor track located below the surface. In this case, the recess extends from the surface of the connection plate to the depth of the conductor track and provides sufficient space for a soldering or welding process.

The connection plate is preferably ring-shaped or can also be designed in the form of a circular segment.

The ends of the hollow conductors are preferably inserted through the through-holes provided in the connection plate and protrude at a distance from the surface on the other side. The hollow conductor ends can also be flush with the surface of the connection plate.

The connection unit or its connection plate is preferably mounted on the stator of the electrical machine or on the hollow conductor ends and has a side facing the winding and a side facing away from the winding. The aforementioned recesses are preferably provided in the side of the connection plate facing away from the winding.

In addition to the connection plate, the aforementioned connection unit preferably comprises a second component or a second section. The second component can have at least one channel integrated therein, which is fluidically connected to several hollow conductor ends and via which the coolant can be fed into the hollow conductors or coolant exiting the hollow conductors can be collected. The connection unit can also comprise two or more integrated channels.

The second component is preferably a separate component that is placed on the connection plate and is tightly connected to the connection plate.

A ring seal can be provided between the connection plate and the second component. Alternatively or additionally, the two parts can also be glued, welded or otherwise tightly connected to each other.

The second component can be made of plastic or metal, for example.

The connection plate or its layers can be made of an insulating material such as GRP, aramid, ceramic or a plastic. Alternatively, the connection plate or individual layers can also be made of a metal, provided that electrical insulation is provided in relation to the hollow conductor ends.

The present invention also relates to a connection unit for the electrical and hydraulic connection of hollow conductors of a winding of an electrical machine. The connection unit comprises a connection plate made of an electrically insulating material, in which a plurality of electrical conductor tracks extending in different planes within the connection plate are integrated, the connection plate having a plurality of through openings for connecting ends of the hollow conductors.

The connection unit can comprise a single or several coolant channels. The coolant channel or channels may optionally be provided in the connection plate, the second component or in both elements. According to a preferred embodiment of the invention, the channel or channels are provided in the form of grooves.

The connection plate or the entire connection unit can be made from several parts or from a single piece. It can be manufactured using an additive manufacturing method or an injection molding process, for example.

### BRIEF DESCRIPTION OF THE NUNG CHARACTERS

The invention is explained in more detail below with reference to the accompanying drawings. It shows:

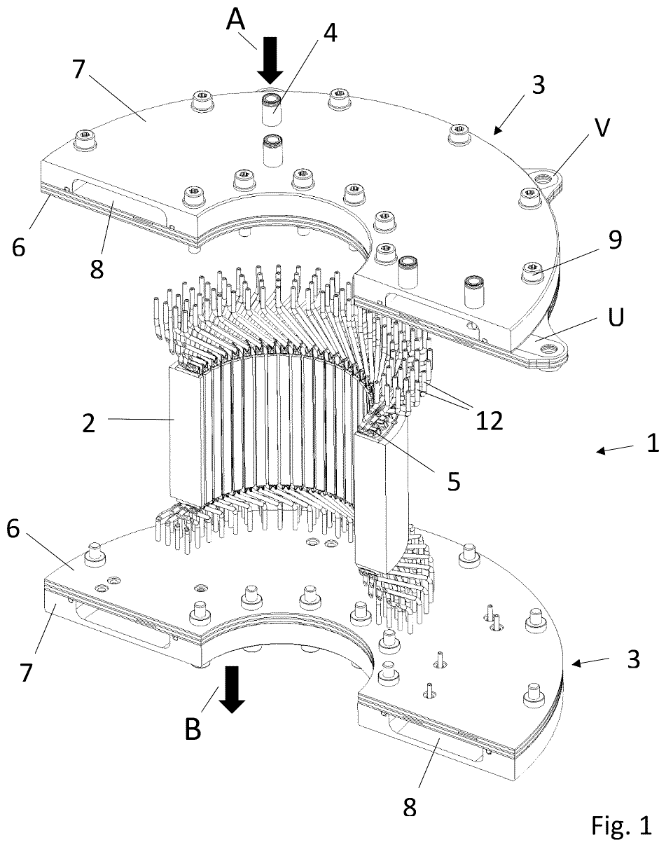

FIG. 1a sectional view of an electrical machine with a hollow conductor winding formed from individual pins and two connection units for the electrical and hydraulic connection of the individual pins;

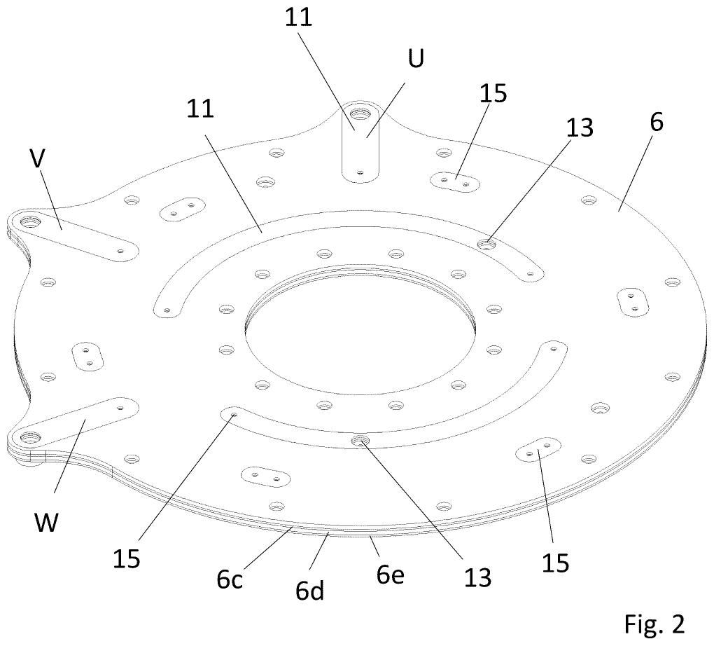

FIG. 2a perspective view of a layer of one of the connection units of FIG. 1;

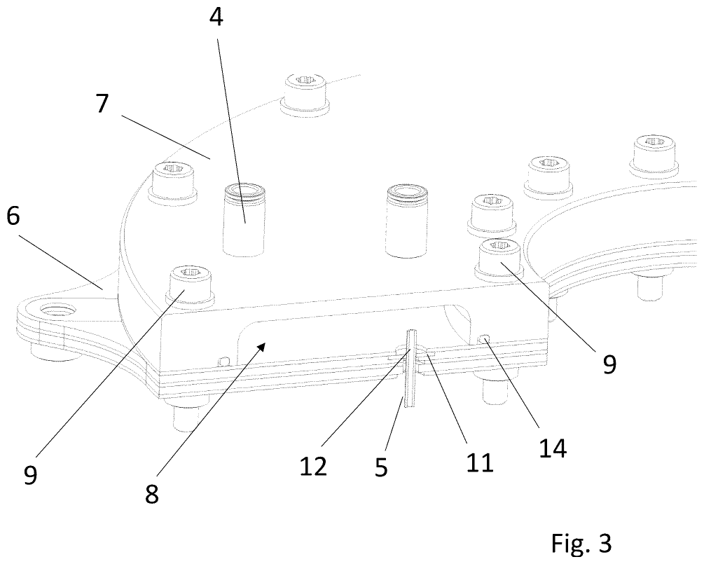

FIG. 3 an enlarged sectional view of one of the connection units of FIG. 1;

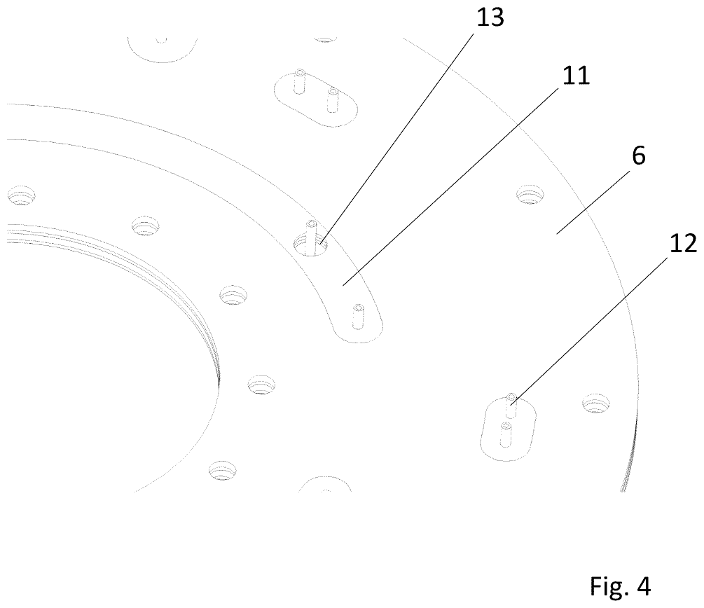

FIG. 4 an enlarged view of the surface of a layer of one of the connection units;

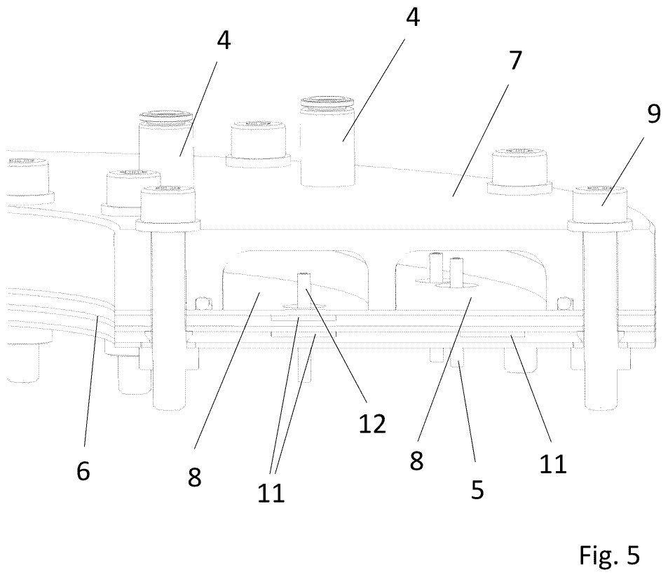

FIG. 5 a connection unit with two integrated coolant ducts.

### EMBODIMENTS OF THE INVENTION

FIG. 1 shows a sectional view of an electrical machine 1 with a stator 2 and a hollow conductor winding formed from individual pins. The pins are each formed as a hollow conductor 5 and comprise an internal channel through which a coolant is conducted in order to cool the electrical machine 1 during operation.

A connection unit 3 is provided on both sides of the stator 2 (top and bottom in the picture), with which the hollow conductors 5 are both electrically contacted and hydraulically integrated into the cooling circuit. Each connection unit 3 comprises a connection plate 6 made of an electrically insulating material, in which several electrical conductor tracks 11 are integrated, running one above the other on different levels. The connection plate 6 also has a plurality of through-openings 15, in each of which one end 12 of the hollow conductor 5 is arranged so that the hollow conductor ends 12 are in electrical contact with at least one of the conductor tracks 11 integrated in the connection plate 6. The cross-section of the through-openings 15 is adapted to the cross-section of the ends of the hollow conductors 5.

The connection unit 3 also comprises a coolant channel 8, via which a coolant can be fed into the hollow conductors 5 or in which the coolant exiting from the hollow conductors 5 can be collected. In the design example shown, all hollow conductors 5 are hydraulically connected in parallel. In this case, the coolant is fed from the outside via a central coolant connector 4 (inlet) into the connection unit 3 shown in the figure above (see arrow A), enters into the coolant channel 8 and then flows through the individual hollow conductors 5, which are all connected hydraulically in parallel, into the connection unit 3 shown in the figure at the bottom. There, the coolant is collected in the channel 8 and discharged to the outside via a central coolant connector (outlet) as shown by arrow B.

In this embodiment, the ducts 8 of the connection units 3 are each formed in a second part 7 or section. The second part 7 is placed on the connection plate 6 and tightly connected to it. A ring seal 14 is provided between the second part 7 and the connection plate 6. Alternatively or additionally, the two parts 6, 7 can also be glued together or otherwise tightly connected to each other. The second part 7 can be made of plastic or metal, for example.

In the embodiment shown, the connection plates 6 are each formed as a sandwich construction of several superimposed plates or layers 6a-6d, which are arranged one above the other in an axial direction of the electrical machine. Each layer 6a-6d is made of an insulating material and may comprise one or more conductive tracks. The individual layers 6a-6d are preferably glued together or can be connected to each other in any other way.

FIG. 2 shows the surface of a layer 6b of the ring-shaped connection plate 6. The layer 6b is made of an electrically insulating material with several conductor tracks 11 embedded in its surface. Hollow conductors 5, which are arranged within the same conductor track 11, are electrically connected to each other via the conductor track 11.

The electrical machine 1 shown in FIG. 1 has a three-phase design and accordingly has three external phase clamps to which the electrical phases U, V and W are connected. The layer 6b shown in FIG. 2 provides electrical connections for all three phases U, V, W.

The individual hollow conductors 5 can be electrically connected via the conductor tracks 11, for example, in such a way that several hollow conductors 5 are connected in series to form a coil. Several such coils belonging to the same electrical phase U, V, W can be connected in parallel.

FIG. 3 shows a sectional view of a connection unit 3, in which the integrated coolant channel 8 is clearly visible. The connection unit 3 comprises a connection plate 6 formed from several layers 6a-6d, on which the second part 7 with the coolant channel 8 is arranged. The two parts are screwed together using screws 9.

FIG. 4 shows an enlarged view of the surface of a layer 6b, in which a recess 13 provided in the surface of the connection plate 6 is clearly visible. The recess 13 is used to contact, in particular to solder or weld, a hollow conductor end 12 located in the through-opening 15 to a conductor track 11 located below the surface. As can be seen, the recess 13 extends from the surface of the connection plate 6 to the depth of the conductor track 11 and provides sufficient space for a soldering or welding process.

The connection unit 3 or its connection plate 6 is preferably mounted on the stator 2 of the electrical machine 1 and has a side facing the winding and a side facing away from the winding. The aforementioned recesses 13 are preferably provided on the side of the connection plate 6 facing away from the winding. However, they could also be provided on the other side.

The connection plate 6 or its layers 6a-6d can be made from an insulating material, such as GRP, aramid, ceramic or a plastic. Alternatively, the connection plate or individual layers could also be made from metal.

Finally, FIG. 5 shows a variant of a connection unit 3 in which two coolant ducts 8 for the forward flow and return flow are integrated. This variant accordingly comprises a hydraulic connection 4 for the forward flow and a second connection 4 for the return flow.

1. An electrical machine, comprising:
a winding formed from a plurality of hollow conductors, each of the plurality of hollow conductors having open ends configured to receive a coolant therein or expel a coolant therefrom, and each of the plurality of hollow conductors having a connection unit configured for electrical and hydraulic connection thereto;
a connection plate configured to integrate a plurality of electrical conductor tracks, the connection plate having a plurality of through openings in which the ends of the plurality of hollow conductors is arranged;
wherein the connection plate has a recess defined in a surface thereof in the region of at least one of the through-openings, the recess configured to facilitate electrical connection to a at least one respective end of one of the plurality of hollow conductors located in the relevant through-opening with a conductor track embedded underneath a surface of the connection plate.

2. The electrical machine according to claim 1, wherein the conductor tracks run at different levels within the connection plate.

3. The electrical machine according to claim 1, wherein the connection plate is a sandwich construction comprising several plates arranged one above the other.

4. The electrical machine according to claim 3, wherein the plates are made of an insulating material in which one or more electrical conductor tracks are integrated.

5. The electrical machine according to claim 1, wherein the connection unit further comprises a second component having a channel defined therein which is connected to a plurality of hollow conductor ends configured to receive the coolant therein or expel the coolant therefrom.

6. The electrical machine according to claim 1, wherein a surface of at least one of the connection plate or a second component includes at least one groove which is connected to a respective one of the plurality of hollow conductor ends and the at least one groove being configured to receive the coolant into one of the plurality of hollow conductors or expel a coolant from one of the plurality of hollow conductors.

7. The electrical machine according to claim 5, wherein the second component is placed on the connection plate and is tightly connected to the connection plate.

8. The electrical machine according to claim 1, wherein at least one of the connection plate and the second component has an annular form.

9. The electrical machine according to claim 5, wherein the second component is made of plastic or metal.

10. The electrical machine according to claim 1, wherein the connection plate includes integrated conductor tracks and is made of an insulating material, a synthetic fiber, a plastic, or a metal.

11. A connection unit for connecting a plurality of hollow conductors of a winding of an electrical machine, comprising:
a connection plate including a plurality of integrated electrical conductor tracks, the connection plate having a plurality of through-openings defined therethrough configured to connect the ends of the respective plurality of hollow conductors,
wherein the connection plate has a recess defined in a surface thereof in the region of at least one of the plurality of through-openings, the recess configured to facilitate electrical connection of at least one respective end of one of the plurality of hollow conductors located in the relevant through-opening with the respective conductor track located beneath the surface.

12. The electrical machine according to claim 6, wherein the second component is placed on the connection plate and is tightly connected to the connection plate.

13. The electrical machine according to claim 1, wherein the connection plate is made from at least one of GFP, aramid and aluminum.
